(19) United States
(12) Patent Application Publication
(10) Pub. No.: US 2015/0371302 A1
(43) Pub. Date: Dec. 24, 2015

(54) SYSTEM AND METHOD FOR PROVIDING CUSTOMERS WITH PRODUCT PURCHASE GUIDANCE IN A RETAIL ENVIRONMENT

(71) Applicant: Meijer, Inc., Grand Rapids, MI (US)

(72) Inventor: Jamie J. Akemann, Ada, MI (US)

(21) Appl. No.: 14/742,003

(22) Filed: Jun. 17, 2015

Related U.S. Application Data
(60) Provisional application No. 62/014,108, filed on Jun. 18, 2014.

(51) Int. Cl. G06Q 30/06; G06F 3/0484

(52) U.S. Cl. CPC G06Q 30/0613; G06F 3/04842

(57) ABSTRACT

A system and method of providing a customer with product purchase guidance in a retail environment may include controlling a display with a processor to display to display a plurality of selectable bulb type GUI elements each corresponding to a different one of a plurality of light bulb types, controlling the display device to display one or more selectable bulb technology GUI elements each corresponding to a different one of one or more light bulb technologies in which a selected one of the light bulb types is manufactured, controlling the display device to display one or more selectable bulb variant GUI elements each corresponding to a different one of one or more variants in which a selected light bulb technology of the selected light bulb type is manufactured, and, controlling the display device to display a selected variant of the selected light bulb technology of the selected light bulb type.

### CROSS-REFERENCE TO RELATED APPLICATION

This patent application claims the benefit of, and priority to, U.S. Provisional Patent Application Ser. No. 62/014,108, filed Jun. 18, 2014, the disclosure of which is incorporated herein by reference.

### FIELD OF THE INVENTION

The present invention relates generally to apparatuses and techniques for providing customers of a retail enterprise with product purchase guidance, and more specifically to systems and methods for providing customers with guidance in the selection and purchase of light bulbs.

### BACKGROUND

Light bulbs, sometimes generically referred to as lamps, are manufactured in a variety of shapes, sizes, wattages, lumen outputs and color temperatures. Moreover, many commercially available light bulbs can be manufactured using any of several different lamp technologies, examples of which include, but are not limited to, incandescent lamps, including general service, tungsten halogen and xenon lamps, fluorescent lamps, including tube-type and compact fluorescent lamps (CFLs), high intensity discharge lamps, including metal halide, high pressure sodium, low pressure sodium and mercury vapor lamps, and light emitting diode (LED) lamps. A bulb selection guidance system and method may facilitate efficient and informed consumer selection and purchase of light bulbs.

### SUMMARY

The present invention may comprise one or more of the features recited in the attached claims, and/or one or more of the following features and combinations thereof. In a first example aspect, a method of providing a customer with product purchase guidance in a retail environment may comprise controlling a display device with a processor to display a plurality of selectable bulb type graphical user interface (GUI) elements each corresponding to a different one of a plurality of light bulb types, in response to receipt by the processor of a signal or message indicating manual selection via a user interface device of one of the displayed plurality of selectable bulb type GUI elements, controlling the display device with the processor to display one or more selectable bulb technology GUI elements each corresponding to a different one of one or more light bulb technologies in which the selected light bulb type is manufactured, in response to receipt by the processor of a signal or message indicating manual selection via the user interface device of one of the displayed one or more selectable bulb technology GUI elements, controlling the display device with the processor to display one or more selectable bulb variant GUI elements each corresponding to a different one of one or more variants in which the selected light bulb technology of the selected light bulb type is manufactured, and in response to receipt by the processor of a signal or message indicating manual selection via the user interface device of one of the displayed one or more selectable bulb variant GUI elements, controlling the display device with the processor to display the selected variant of the selected light bulb technology of the selected light bulb type.

A second example aspect includes the subject matter of the first example aspect and further includes controlling the display device with the processor to display a planogram highlighting a location of the selected variant of the selected light bulb technology of the selected light bulb type relative to retail shelving located in the retail environment.

A third example aspect includes the subject matter of the second example aspect and further includes controlling with the processor wireless communication circuitry coupled thereto to transmit to an identified mobile communication device an image of the highlighted planogram.

A fourth example aspect includes the subject matter of the third example aspect and further includes receiving via wireless communication circuitry coupled to the processor a wirelessly transmitted signal or message including at least one code, and processing by the processor of the wirelessly received at least one code to identify the mobile communication device for purposes of transmitting thereto the image of the highlighted planogram.

A fifth example aspect includes the subject matter of the first example aspect and further includes controlling with the processor wireless communication circuitry coupled thereto to transmit to an identified mobile communication device information about selected variant of the selected light bulb technology of the selected light bulb type.

A sixth example aspect includes the subject matter of the fifth example aspect and further includes receiving via wireless communication circuitry coupled to the processor a wirelessly transmitted signal or message including at least one code, and processing by the processor of the wirelessly received at least one code to identify the mobile communication device for purposes of transmitting thereto the information about selected variant of the selected light bulb technology of the selected light bulb type.

A seventh example aspect includes the subject matter of the fourth example aspect and wherein the information about the selected variant of the selected light bulb technology of the selected light bulb type includes an image of the selected variant of the selected light bulb technology of the selected light bulb type.

An eighth example aspect includes the subject matter of the first example aspect and wherein the retail environment includes therein retail shelving having stocked thereon a plurality of different light bulbs for retail sale, and a light bulb identification system configured to selectively highlight locations of one or more of the plurality of different light bulbs stocked on the retail shelving, and wherein the method further comprises controlling with the processor the light bulb identification system to highlight a location of the retail shelving at which the selected variant of the selected light bulb technology of the selected light bulb type is located.

A ninth example aspect includes the subject matter of the first example aspect and wherein controlling the display device to display the plurality of selectable bulb type graphical user interface (GUI) elements includes controlling the display device with the processor to display a plurality of selectable light bulb application GUI elements each corresponding to a different one of a plurality of light bulb applications in which light bulbs are used, and in response to receipt by the processor of a signal or message indicating manual selection via the user interface device of one of the displayed plurality of selectable light bulb application GUI elements, accessing with the processor a database of light bulb information and determining therefrom the plurality of light bulb types as a subset of a plurality of light bulbs usable in the selected light bulb application.

A tenth example aspect includes the subject matter of the first example aspect and wherein controlling the display device to display the plurality of selectable bulb type graphical user interface (GUI) elements includes controlling the display device with the processor to display a plurality of selectable light bulb fixture GUI elements each corresponding to a different one of a plurality of light bulb fixtures in which light bulbs are used, and in response to receipt by the processor of a signal or message indicating manual selection via the user interface device of one of the displayed plurality of selectable light bulb fixture GUI elements, accessing with the processor a database of light bulb information and determining therefrom the plurality of light bulb types as a subset of a plurality of light bulbs usable with the selected light bulb fixture.

An eleventh example aspect includes the subject matter of the tenth example aspect and wherein controlling the display device to display the plurality of selectable light bulb fixture GUI elements includes controlling the display device with the processor to display a plurality of selectable light bulb fixture type GUI elements each corresponding to a different one of a plurality of types of light bulb fixtures in which light bulbs are used, and in response to receipt by the processor of a signal or message indicating manual selection via the user interface device of one of the displayed plurality of selectable light bulb fixture type GUI elements, controlling the display device with the processor to display a plurality of selectable light bulb fixture manufacturer GUI elements each corresponding to a different one of one or more light fixture manufacturers that manufacture the selected type of light bulb fixture, accessing with the processor a database of light bulb information and determining therefrom the plurality of light bulb types as the subset of a plurality of light bulbs usable with the selected light bulb fixture type and manufactured by the selected light bulb fixture manufacturer.

A twelfth example aspect includes the subject matter of the eleventh example aspect and wherein controlling the display device to display the plurality of selectable light bulb fixture GUI elements further comprises controlling the display device with the processor to display a plurality of selectable light bulb fixture model GUI elements each corresponding to a different one of one or more light bulb fixture models of the selected light bulb fixture type and manufactured by the selected light bulb fixture manufacturer, and wherein determining the plurality of light bulb types further comprises accessing with the processor the database of light bulb information and determining therefrom the plurality of light bulb types as a subset of the plurality of light bulbs usable with the selected light bulb fixture model of the selected light bulb fixture type that is manufactured by the selected light bulb fixture manufacturer.

A thirteenth example aspect includes the subject matter of the first example aspect and wherein controlling the display device to display the plurality of selectable bulb type graphical user interface (GUI) elements includes controlling the display device with the processor to display a plurality of selectable light bulb shape GUI elements each corresponding to a different one of a plurality of light bulb shapes, and in response to receipt by the processor of a signal or message indicating manual selection via the user interface device of one of the displayed plurality of selectable light bulb shape GUI elements, accessing with the processor a database of light bulb information and determining therefrom the plurality of light bulb types as a subset of a plurality of light bulbs each having the selected light bulb shape.

A fourteenth example aspect includes the subject matter of the first example aspect and wherein controlling the display device to display the plurality of selectable bulb type graphical user interface (GUI) elements includes controlling the display device with the processor to display a plurality of selectable light bulb size GUI elements each corresponding to a different one of a plurality of light bulb sizes, and in response to receipt by the processor of a signal or message indicating manual selection via the user interface device of one of the displayed plurality of selectable light bulb size GUI elements, accessing with the processor a database of light bulb information and determining therefrom the plurality of light bulb types as a subset of a plurality of light bulbs each having the selected light bulb size.

A fifteenth example aspect includes the subject matter of the first example aspect and wherein controlling the display device to display the plurality of selectable bulb type graphical user interface (GUI) elements includes controlling the display device with the processor to display a plurality of selectable light bulb output GUI elements each corresponding to a different one of a plurality of light output or electrical power consumption values, and in response to receipt by the processor of a signal or message indicating manual selection via the user interface device of one of the displayed plurality of selectable light bulb output GUI elements, accessing with the processor a database of light bulb information and determining therefrom the plurality of light bulb types as a subset of a plurality of light bulbs each having the selected light bulb light output or electrical power consumption values.

A sixteenth example aspect includes the subject matter of the first example aspect and wherein controlling the display device to display the one or more selectable bulb technology GUI elements comprises controlling the display device with the processor to display the selected light bulb type in the form of one or more of an incandescent bulb, a fluorescent bulb and a light emitting diode bulb.

A seventeenth example aspect includes the subject matter of the first example aspect and wherein controlling the display device with the processor to display one or more selectable bulb variant GUI elements comprises controlling the display device with the processor to display the selected light bulb technology of the selected light bulb type in the form of one or more of a color temperature, color rendering index (CRI), estimated bulb lifetime, energy-efficiency, coating type, clear, colored and shatter-resistant option.

In an eighteenth example aspect, a system is provided for providing a customer with product purchase guidance in a retail environment, which may include a display device, a user interface device, a processer coupled to the display device and to the user input device, and a memory having instructions stored therein which, when executed by the processor, cause the processor to control the display device to display a plurality of selectable bulb type graphical user interface (GUI) elements each corresponding to a different one of a plurality of light bulb types, to control the display device, in response to receipt of a signal or message indicating manual selection via the user interface device of one of the displayed plurality of selectable bulb type GUI elements, to display one or more selectable bulb technology GUI elements each corresponding to a different one of one or more light bulb technologies in which the selected light bulb type is manufactured, to control the display device, in response to receipt of a signal or message indicating manual selection via the user interface device of one of the displayed one or more selectable bulb technology GUI elements, to display one or more selectable bulb variant GUI elements each corresponding to a different one of one or more variants in which the selected light bulb technology of the selected light bulb type is manufactured, and to control the display device, in response to receipt of a signal or message indicating manual selection via the user interface device of one of the displayed one or more selectable bulb variant GUI elements, to display the selected variant of the selected light bulb technology of the selected light bulb type.

A nineteenth example aspect includes the subject matter of the eighteenth example aspect and wherein the instructions stored in the memory further include instructions which, when executed by the processor, cause the processor to control the display device to display a planogram highlighting a location of the selected variant of the selected light bulb technology of the selected light bulb type relative to retail shelving located in the retail environment.

A twentieth example aspect includes the subject matter of the eighteenth example aspect and further includes wireless communication circuitry coupled to the processor, and wherein the instructions stored in the memory further include instructions which, when executed by the processor, cause the processor to control the wireless communication circuitry to transmit to an identified mobile communication device at least one of a planogram highlighting a location of the selected variant of the selected light bulb technology of the selected light bulb type relative to retail shelving located in the retail environment and an image of the selected variant of the selected light bulb technology of the selected light bulb type.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for providing customers with product purchase guidance in a retail environment.

FIG. 2 is a simplified block diagram of an embodiment of the retail enterprise server illustrated in FIG. 1

FIG. 3 is a simplified block diagram of an embodiment of the user interface device illustrated in FIG. 1.

FIG. 4 is a simplified block diagram of a software environment of the retail enterprise server illustrated in FIGS. 1 and 2.

FIG. 5 is a simplified flow diagram of a process for providing customers with light bulb purchase guidance in a retail environment using the system illustrated in FIGS. 1-4

FIG. 6 is an example screen shot of the display screen of the user interface device illustrated in FIG. 1 illustrating an example of the process illustrated in FIG. 5.

FIG. 7 is an example screen shot of the display screen of the user interface device illustrated in FIG. 1 continuing with the example process illustrated in FIG. 6.

FIG. 8 is an example screen shot of the display screen of the user interface device illustrated in FIG. 1 continuing with the example process illustrated in FIGS. 6-7.

FIG. 9 is an example screen shot of the display screen of the user interface device illustrated in FIG. 1 continuing with the example process illustrated in FIGS. 6-8.

FIG. 10 is an example screen shot of the display screen of the user interface device illustrated in FIG. 1 continuing with the example process illustrated in FIGS. 6-9.

FIG. 11 is an example screen shot of the display screen of the user interface device illustrated in FIG. 1 continuing with the example process illustrated in FIGS. 6-10.

FIG. 12 is an example screen shot of the display screen of the user interface device illustrated in FIG. 1 continuing with the example process illustrated in FIGS. 6-11.

FIG. 13 is an example screen shot of the display screen of the user interface device illustrated in FIG. 1 continuing with the example process illustrated in FIGS. 6-12.

FIG. 14 is an example screen shot of the display screen of the user interface device illustrated in FIG. 1 continuing with the example process illustrated in FIGS. 6-13.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

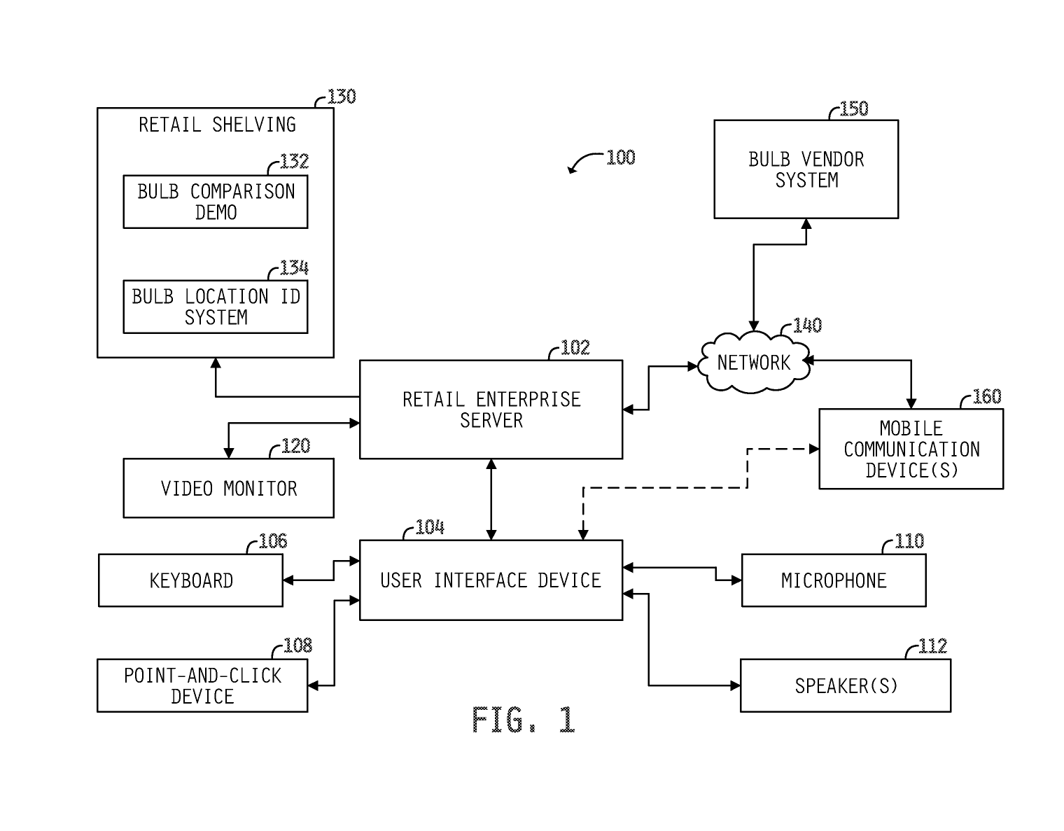

Referring now to FIG. 1, a system 100 is shown for providing customers with product purchase guidance in a retail environment. In the illustrated embodiment, the system 100 includes a retail enterprise server 102 communicatively coupled, e.g., via wired or wireless interface, to a user interface device 104. The user interface device 104 may be communicatively coupled, e.g., via wired or wireless interface to any one or more of a keyboard 106, a point-and-click device 108, a microphone 110 and one or more speakers 112.

The retail environment illustratively includes on-site retail shelving 130, and the retail shelving 130 may include a bulb comparison demonstration area 132 and/or a bulb location identification system 134. In embodiments that include the bulb demonstration area 132, this area may be equipped with bulbs of the same type but of different light bulb technologies, e.g., incandescent, halogen, CFL, and/or LED, in order to provide for live demonstration and comparison of the illumination characteristics of each. In embodiments that include the bulb location identification system 134, such a system 134 may include one or more light bars or tracks that may be selectively illuminated under the control of the retail enterprise server 102 to selectively highlight areas of the retail shelving 130, e.g., to highlight one or more light bulbs relative to the retail shelving 130 as an aid in locating the one or more light bulbs for customer selection thereof.

The system 100 further includes a conventional network 140 via which the retail enterprise server 102 may communicate wirelessly with one or more bulb vendor systems 150 and/or one or more mobile communication devices 160. Alternatively or additionally, the user interface device 104 may include wireless communication capability such that the device 104 may wirelessly communicate directly with the mobile communication device(s) 160.

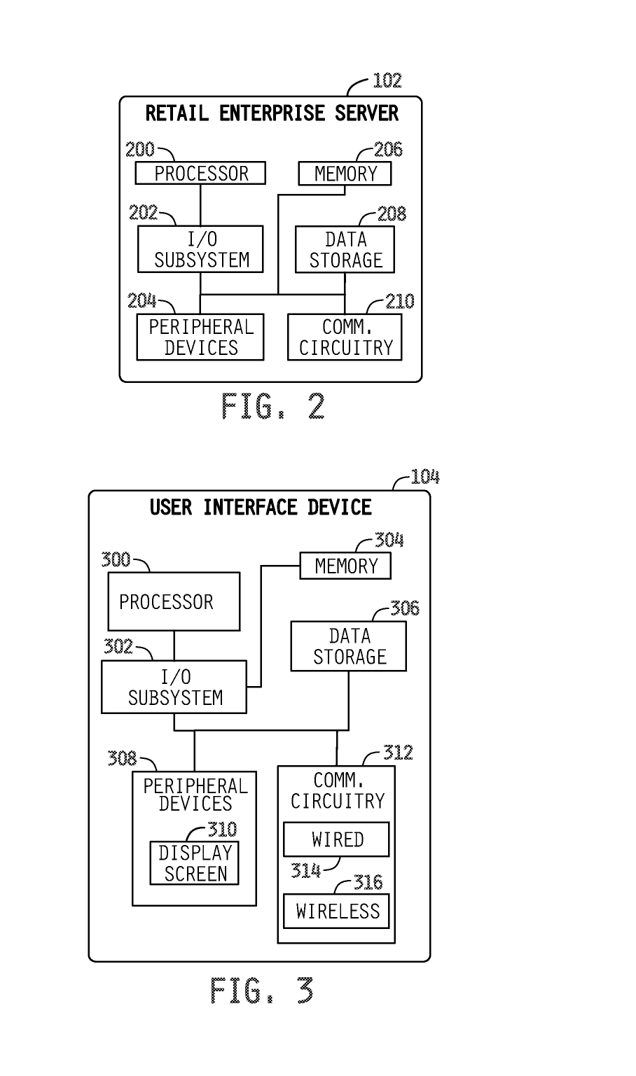

Referring to FIG. 2, the retail enterprise server 102 may illustratively include a processor 200 coupled via an I/O subsystem 202 to one or more conventional peripheral devices 204, one or more memory devices 206, one or more data storage devices 208 and a conventional communication circuitry 210 that may be configured for wireless communication with one or more of the devices of the system 100 via the network 140. Additionally, the communication circuitry 210 may be configured for wired communications with one or more devices of the system 100.

Referring to FIG. 3, the user interface device 104 may illustratively include a processor 300 coupled via an I/O subsystem 302 to one or more memory devices 304, one or more data storage devices 306 and a conventional communication circuitry 312 that includes a wired communication circuit 314, i.e., configured for wired communications, and a wireless communication circuit 316, i.e., configured for wireless communications. The I/O subsystem 302 is further coupled to a number of conventional peripheral devices 308 which illustratively includes a display screen 310. In one embodiment, the display screen 310 is a conventional “touch screen” display that is configured to receive user input via physical contact with the screen surface. Alternatively or additionally, input to the user interface device may be accomplished via the keyboard 106 and/or point-and-click device 108.

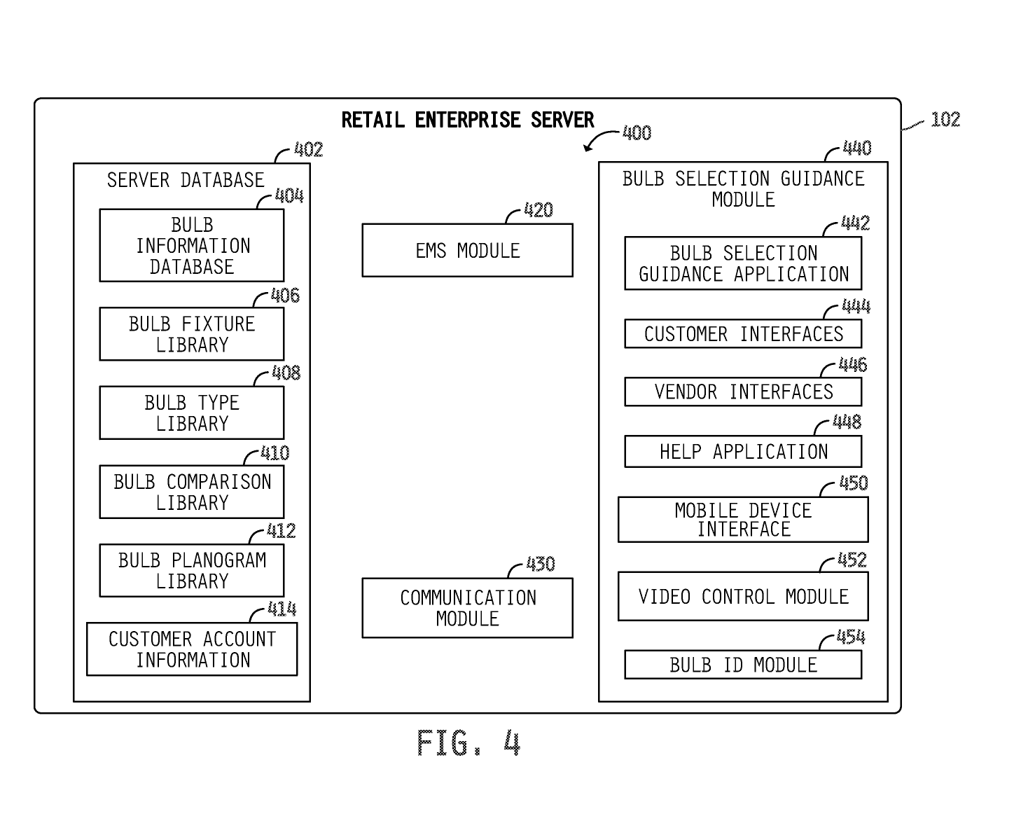

Referring now to FIG. 4, a simplified block diagram is shown of a software environment 400 of the enterprise server 102. In the illustrated embodiment, the software environment 400 includes a server database 402 which illustratively includes a bulb information database 404 populated with pricing and descriptive information relating to a plurality of light bulbs available for purchase from the retail enterprise, a bulb fixture library 406 populated with information relating various light bulbs to various fixtures in which they may be used, a bulb type library 408 populated with information on the different types of bulbs available for purchase from the retail enterprise, a bulb comparison library 410 populated with information comparing pricing and/or performance characteristics of various light bulbs, a bulb planogram library 412 populated with planograms identifying the location of various light bulbs relative to retail store shelving 130 and customer account information. The environment 400 further includes an enterprise membership service (EMS) module 420 that tracks and accesses customer accounts in relation to an enterprise membership service hosted by the retail enterprise, a communication module 430 which controls communication between the server 102 and other devices of the system 100 and a bulb selection guidance module 440. The module 440 illustratively includes a bulb selection guidance application 442, a number of customer interfaces 444 and vendor interfaces 446, a help application 448, a mobile device interface 450, a video control module 452, e.g., for controlling a video monitor 120 of the system 100, and a bulb identification module 454. The bulb selection guidance module illustratively executes the bulb selection guidance application 442 via the user interface device 104 as described below.

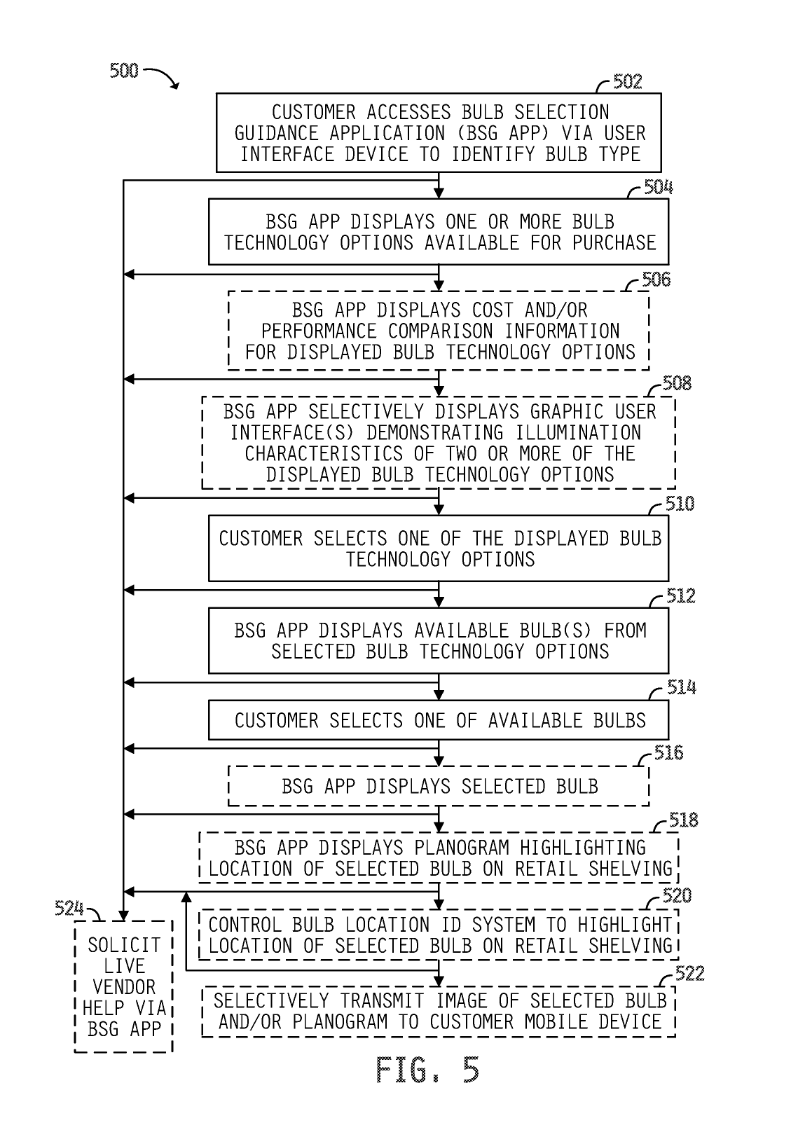

Referring now to FIG. 5, a process 500 for providing customers with light bulb purchase guidance in a retail environment is shown. In one embodiment, the process 500 is stored in the memory 206 of the retail enterprise server 102 (and/or data storage 208) of the retail enterprise server 102 in the form of instructions executable by the processor 200 of the retail enterprise server 102, and the process steps of this portion of the process 500 will be described below for purposes of this disclosure as being executed by the processor 200 of the retail enterprise server 102. It will be understood, however, that in some alternate embodiments, the process 500 may be alternatively stored in the memory 304 (and/or data storage 306) of the user interface device 104 in the form of instructions executable by the processor 300 of the user interface device 104, and in other embodiments the process 500 may be stored, in whole or in part, in each of the memory 204 (and/or data storage 206) of the retail enterprise server 102 and the memory 304 (and/or data storage 306) of the user interface device 104 in the form of instructions executable in part by the processor 200 of the retail enterprise server 102 and in part by the processor 300 of the user interface device 104, wherein information may be shared between the retail enterprise server 102 and the user interface device 104 via wired and/or wireless connection.

In the following description, references will be made to acts executed by a customer and to acts executed by the bulb selection guidance application 442. It will be understood that in the former case, such acts will be carried out by the processor 200 in response to customer input to or selection of information displayed on the display screen 310 of the user interface device 104, and in the latter case such acts will be carried out by the processor 200 via suitable control of the display screen 310 of the user interface device 104. In any case, the process 500 begins at step 502 where the customer accesses the bulb selection guidance application (BSG App) being executed by the processor 200 of the user interface device 104 to identify a type of light bulb; that is to say, generally a shape and output power (e.g., in Watts and/or lumen output) of the light bulb being sought. In one embodiment, the processor 200 may carry out the step 502 by displaying, e.g., in the form of a plurality of selectable graphical user interface (GUI) elements, a list of bulb applications, e.g., from the bulb fixture library 406 or bulb type library 408, corresponding to an application in which the bulb being sought is to be used. Examples of bulb applications that may be displayed and selected at step 502 include, but are not limited to, “kitchen,” “bath,” “outdoor,” “general purpose,” “specialty,” and the like.

Alternatively or additionally, the processor 200 may carry out step 502 by displaying, e.g., in the form of a plurality of selectable graphical user interface (GUI) elements, a list of fixture types in which the bulb being sought will be used, e.g., from the bulb fixture library 406. Examples of fixture types that may be displayed and selected at step 502 include, but are not limited to, “ceiling fan,” “refrigerator,” “stove/oven,” “microwave oven,” “track lighting,” “recessed lighting,” “table/floor lamp” and the like. Additionally, in embodiments in which the processor 200 carries out step 502 by displaying, e.g., in the form of a plurality of selectable graphical user interface (GUI) elements, a list of fixture types, the processor 200 may further carry out step 502 by displaying a list of fixture manufacturers e.g., from the bulb fixture library 406, once the customer has selected a fixture type. Examples of fixture manufacturers may include any manufacturer of the selected fixture, e.g., any manufacturer of a ceiling fan. Alternatively or additionally, in embodiments in which the processor 200 carries out step 502 by displaying a list of fixture types and/or fixture manufacturers, the processor 200 may further carry out step 502 by displaying, e.g., in the form of a plurality of selectable graphical user interface (GUI) elements, a list of fixture models e.g., from the bulb fixture library 406, produced by various manufacturers of the selected fixture or produced by the selected fixture manufacturer. Examples of fixture models may include any manufactured model of the selected fixture, e.g., any model of a ceiling fan produced by any manufacturer of ceiling fans or by a selected manufacturer of ceiling fans.

Alternatively or additionally, the processor 200 may carry out step 502 by displaying, e.g., in the form of a plurality of selectable graphical user interface (GUI) elements, a list of bulb types, e.g., from the bulb type library 408, from which the customer may select that best fits the type, e.g., shape, of the bulb being sought. Examples of bulb types that may be displayed and selected at step 502 include, but are not limited to, “general purpose,” “CFL,” “Candle,” “Vanity/Globe,” “Indoor Flood,” “Outdoor Flood” and the like.

Alternatively or additionally, the processor 200 may carry out step 502 by displaying, e.g., in the form of a plurality of selectable graphical user interface (GUI) elements, a list of lumen outputs and/or power consumption values (e.g., wattages) from which the customer may select that best fits the lumen output and/or power consumption of the bulb being sought. Examples of the latter include, but should not be limited to, “100 Watt,” “75 Watt,” “60 Watt” and the like.

Alternatively or additionally, the processor 200 may carry out step 502 by displaying, e.g., in the form of a plurality of selectable graphical user interface (GUI) elements, a list of bulb sizes (e.g., PAR values) from which the customer may select that best fits the size of the bulb being sought. Examples of this include, but should not be limited to, “PAR 20,” “PAR 30,” “PAR 46” and the like.

Alternatively or additionally, the processor 200 may carry out step 502 by displaying a search interface, e.g., in the form of one or a plurality of graphical user interfaces (GUIs) and/or GUI elements, configured to accept customer input of one or more lamp parameters from which to search the bulb information database to determine the type of the bulb being sought. Examples of the one or more lamp parameters that the customer may identify at step 502 include, but should not be limited to, lamp size, e.g., “PAR 20,” lamp wattage, e.g., “40 Watt,” manufacturer part or serial number, or the like.

It will be understood that any one or more of the foregoing examples of step 502 may be combined to form a series or sequence of sub-steps. For example, in one embodiment, step 502 may comprise the combination of selecting a bulb application, followed by fixture type, followed by wattage. In another embodiment, step 502 may comprise an initial selection of either fixture type or bulb type and, depending upon an initial selection by the customer as between these two options, the remainder of step 502 may include selection of bulb type and then wattage, in the case of initial customer selection of fixture type, or selection of bulb wattage in the case of initial customer selection of bulb type. It will further be understood that any of the foregoing references to displaying a “list” may include any one or combination of displaying a text list, displaying a bulb name, displaying an image, displaying a description of the bulb, or the like.

Following selection at step 502 by the customer of a bulb type, the process 500 advances to step 504 where the BSG App is operable to display, e.g., in the form of one or more selectable bulb technology graphical user interface (GUI) elements, one or more bulb technology options available for purchase, i.e., one or more bulb technologies in which light bulbs of the selected type are manufactured by one or more third-party light bulb manufacturers. Examples of bulb technology options available for purchase include one or more bulb technologies carried by the retail enterprise for purchase by customers that meet the technical specifications for, and can be used as, the type of bulb being sought. Examples of bulb technologies that may be available include, but are not limited to, incandescent lamps, including general service, tungsten halogen and/or xenon lamps, fluorescent lamps, including tube-type and/or compact fluorescent lamps (CFLs), high intensity discharge lamps, including metal halide, high pressure sodium, low pressure sodium and/or mercury vapor lamps, and light emitting diode (LED) lamps. It will be understood that any of the foregoing references to “display” may include any one or combination of displaying a text list, displaying a bulb name, displaying an image, displaying a description of the bulb, or the like.

Optionally, as shown by dashed-line representation, the process 500 may include a step 506 in which the BSG App is operable to supplement the display of the one or more bulb technology options with a display, e.g., in the form of one or more graphical user interface (GUI) elements, of cost and/or performance comparison information. Such cost and/or performance comparison information may include, but should not be limited to, least expensive, most expensive, longest lasting, expected bulb lifetime, energy savings per year, month or other time period, energy savings over expected lifetime of the bulb, recommended for application, or the like. Recommendations for the application may, for example, take into consideration the type of fixture and its expected location, importance of maintaining operability, ease or difficulty of replacing the bulb, and the like. It will be understood that any of the foregoing references to “display” may include any one or combination of displaying a text list, displaying a bulb name, displaying an image, displaying a description of the bulb, or the like.

Further optionally, as also shown by dashed-line representation, the process 500 may include a step 508 in which the BSG App is operable to selectively (e.g., in response to user selection or input) display for comparison one or more graphic user interface(s), e.g., in the form of a depiction, animated gif, video snippet or the like, demonstrating the illumination characteristics of two or more of the displayed bulb technology options. For example, one user selection at step 508 may compare actual video footage of a room being illuminated by a CFL lamp alongside the same room being illuminated by an LED lamp of the same bulb type.

In any case, the process 500 advances from any of steps 504, 506 and 508 to step 510 where the customer selects one of the displayed bulb technologies, e.g., “incandescent” or “halogen.” Thereafter at step 512, the BSG App displays, e.g., in the form of one or more selectable bulb variant graphical user interface (GUI) elements, one or more available bulbs from the selected technology that are available for purchase from the retail enterprise. In the foregoing context, one or more “available bulbs” means one or more versions or variants or models of the type and technology of bulb selected by the customer that is offered for purchase by the retail enterprise. The term version or variant or model may illustratively refer to any one or combination of, but not limited to, color temperature, color rendering index (CRI), expected or estimated bulb lifetime, energy-efficiency, coating type (or lack of coating), e.g., frosted or other diffusive coating (e.g., producing so-called “soft” light), clear (e.g., no coating or minimally diffusive coating), colored, shatter-resistant or otherwise protective coating, etc. As an example, a 75 Watt general purpose bulb may be available in the form of variants, versions or models which include a “soft white” bulb, a “clear” bulb and a “long life soft white bulb,” and in such an example the BSG App would display, e.g., in the form of one or more selectable bulb variant graphical user interface (GUI) elements, all three such variants, versions or models at step 512. It will be understood that any of the foregoing references to “display” may include any one or combination of displaying a text list, displaying a bulb name, displaying an image, displaying a description of the bulb, or the like.

From step 512, the process 500 advances to step 514 where the customer selects one of the “available bulbs” displayed at step 512, i.e., one of the displayed versions or variants or models thereof. Thereafter, the BSG may optionally display, e.g., in the form of one or more graphical user interfaces (GUIs) or GUI elements, the finally selected bulb on the display screen 310 at step 516. Alternatively or additionally, the process 500 may include a step 518 where the BSG App displays, e.g., in the form of one or more images, graphical user interfaces (GUIs) and/or GUI elements, a planogram, e.g., from the bulb planogram library 412, highlighting a location of the light bulb selected at step 514 on or relative to the retail shelving 130 in the store. In one example implementation of this step, the BSG App may display a planogram of the area of the retail shelving 130 in which the selected bulb is located, and then outline or otherwise highlight the displayed planogram to indicate the relative or precise location of the selected bulb within the displayed planogram. Since the planogram is generally an accurate depiction of the actual store shelving 130, such a display will assist the customer in locating the selected bulb on the retail shelving. Alternatively or additionally, the process 500 may include the step 520 where the processor 200 is operable to control the bulb location ID system 134 to highlight the location of the selected bulb at or on the actual retail shelving 130.

Alternatively or additionally still, the process 500 may include the step 522 where the processor 200 is operable to control the communication circuitry 210 and/or the communication circuitry 312 to selectively transmit an image of, and/or other information relating to, the selected bulb and/or an image of the highlighted planogram to the customer's mobile communication device 160. Generally, step 522 will require the customer to enter a suitable code into the user interface device 104 that identifies the contact number, e.g. telephone number, or email address of the customer's mobile device 160. In one embodiment, the suitable code may be the telephone number of the customer's mobile telephone or the customer's email address, and in other embodiments the suitable code may be the customer's enterprise membership service (EMS) code(s) which identify the customer to the retail enterprise server and from which the retail enterprise server may access the customer's email address(es), telephone number(s), and the like. In any case, the image(s) may be transmitted to the customer's mobile device 160 via email or a mobile messaging service, and the customer may then access the image(s) on the display screen of the mobile communication device 160 to facilitate locating the selected bulb on the retail shelving.

As shown by dashed-line representation, the process 500 may further include the step 524 where the customer at any time may selectively solicit live help from a vendor, i.e., manufacturer, of the selected light bulb or of light bulbs generally, via the BSG App. Upon selection of this feature, the customer will be connected, via an on-screen chat session and/or 2-way audio, with a live vendor representative for consultation and answering of any questions relating to light bulb selection. Illustratively, in embodiments that include step 524, step 524 may be accessed at any one or more of the steps of the process 500 as illustrated in FIG. 5.

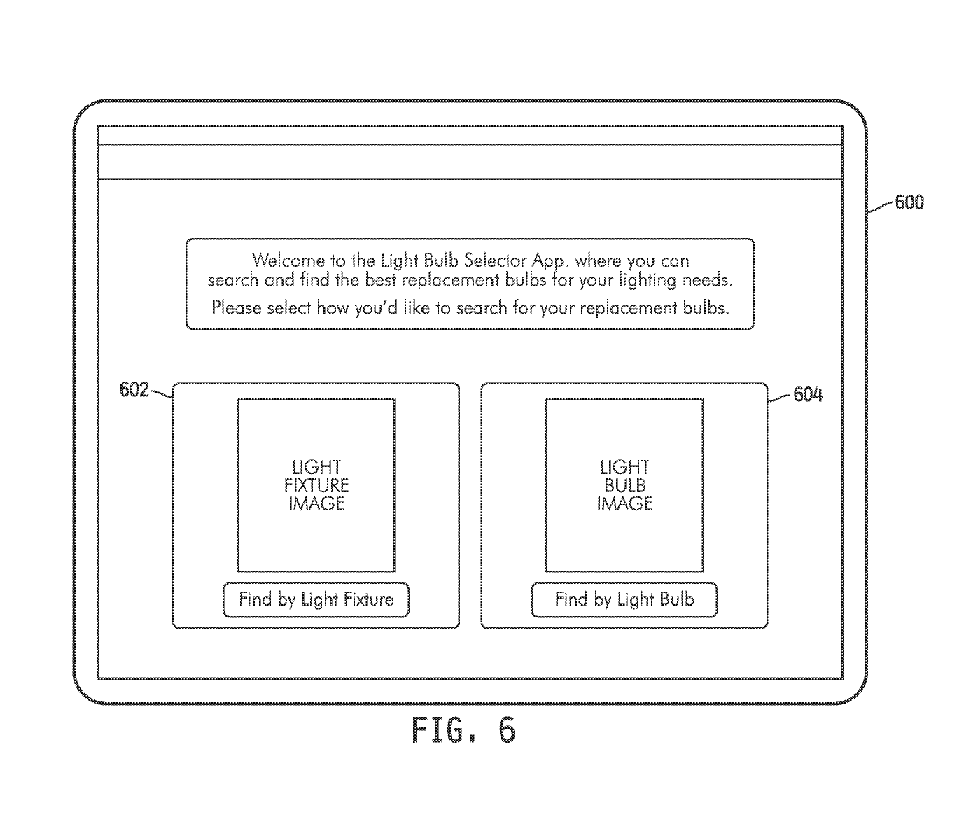

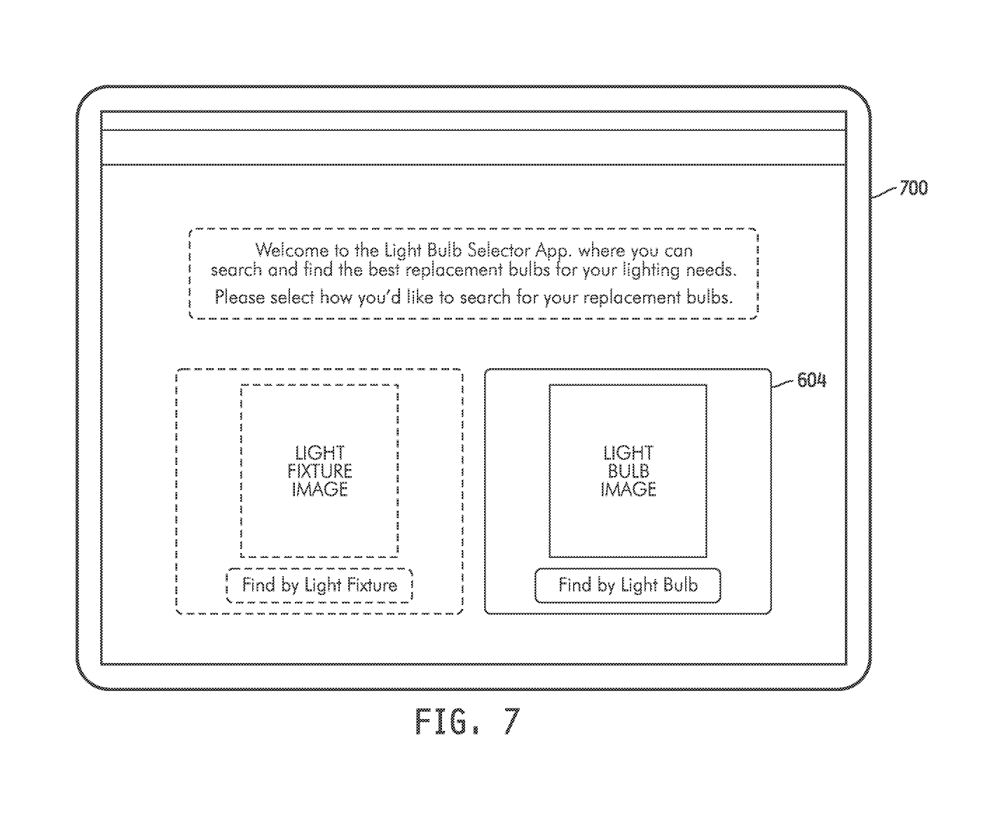

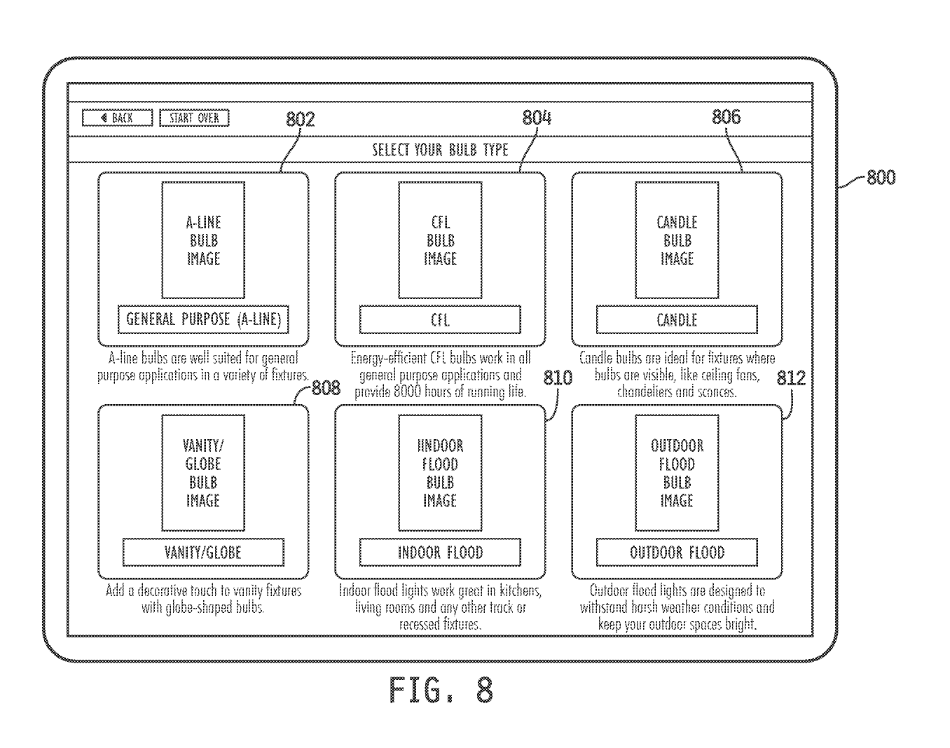

Referring now to FIGS. 6-14, an example of the process 500 illustrated and described with respect to FIG. 5 is provided in the form of a series of screen shots that are representative of what may be displayed on the display screen 310 of the user interface device 104 under control of the processor 200 in response to customer selections/inputs to the user interface device 104. In the screen shot 600 illustrated in FIG. 6, for example, the customer is presented, pursuant to step 502 of the process 500, with the option of identifying a light bulb by light fixture 602 or by bulb type 604. In the screen shot 700 illustrated in FIG. 7, the customer has selected light bulb type 604 as the mechanism by which the customer wishes to locate the bulb being sought. Still pursuant to step 502 of the process 500, the screen shot 800 of FIG. 8 illustrates an example of a series of light bulb types from which the customer may select to narrow the search for the bulb being sought. In the illustrated screen shot 800, the bulb type choices include General Purpose 802, CFL 804, Candle 806, Vanity/Globe 808, Indoor Flood 810 and Outdoor Flood 812.

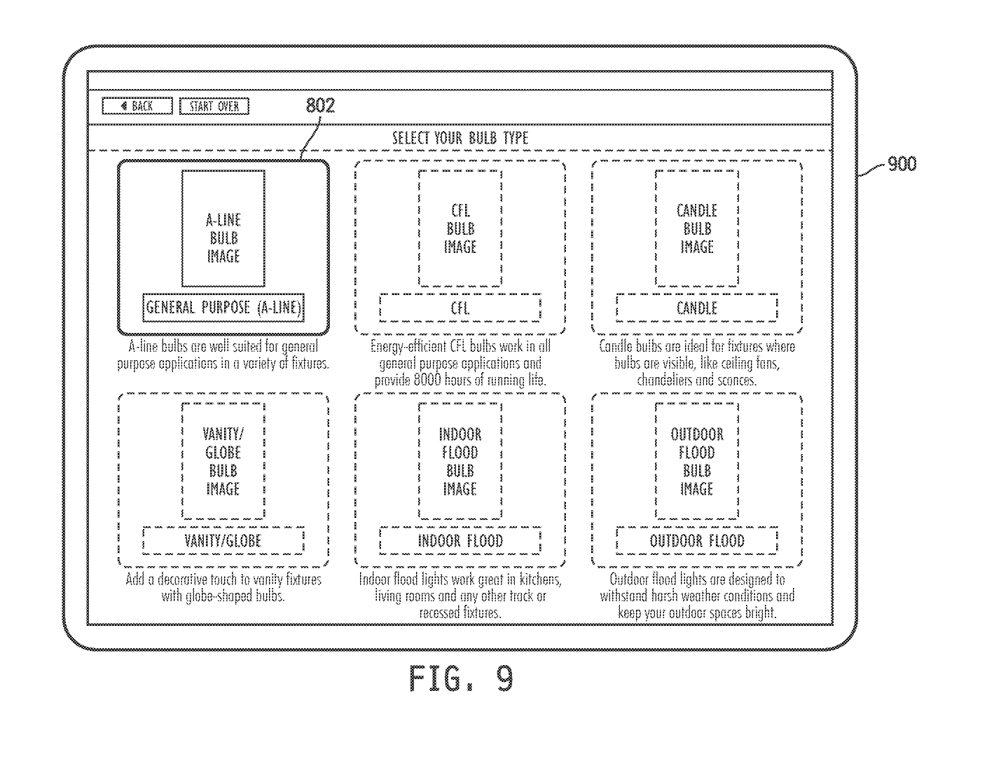

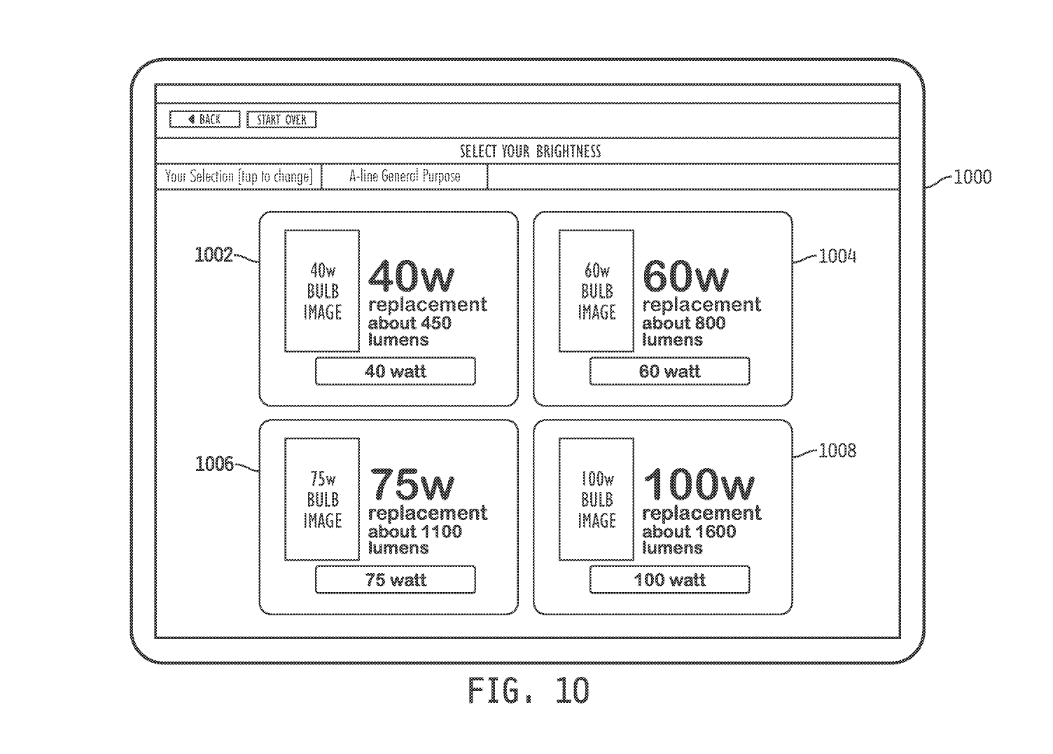

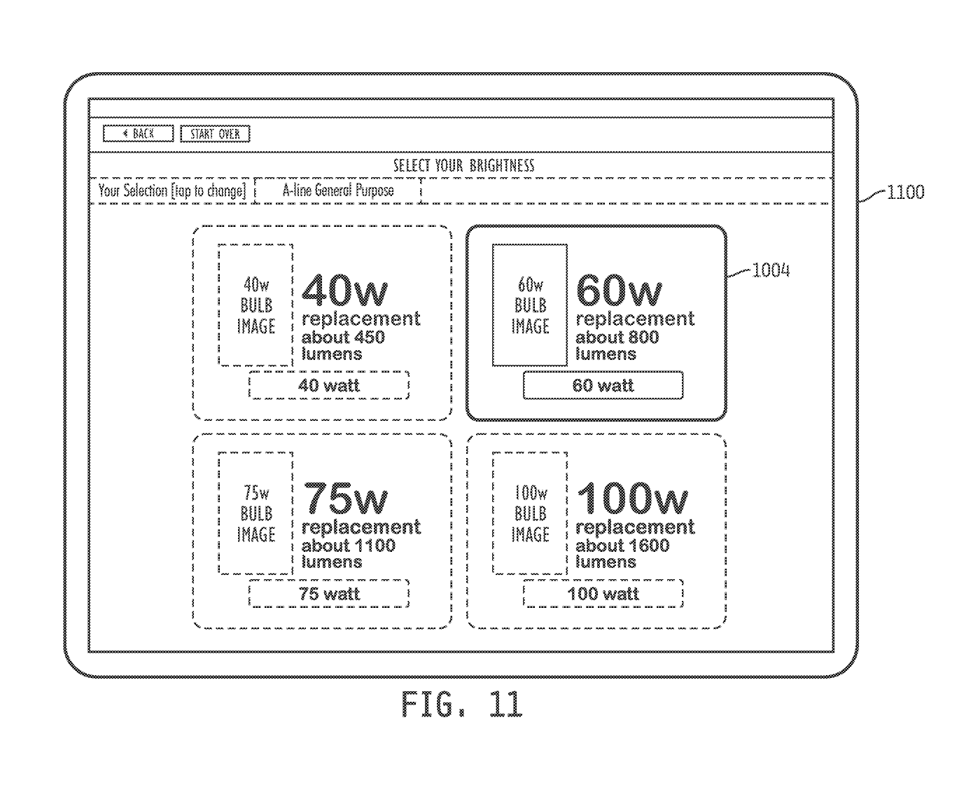

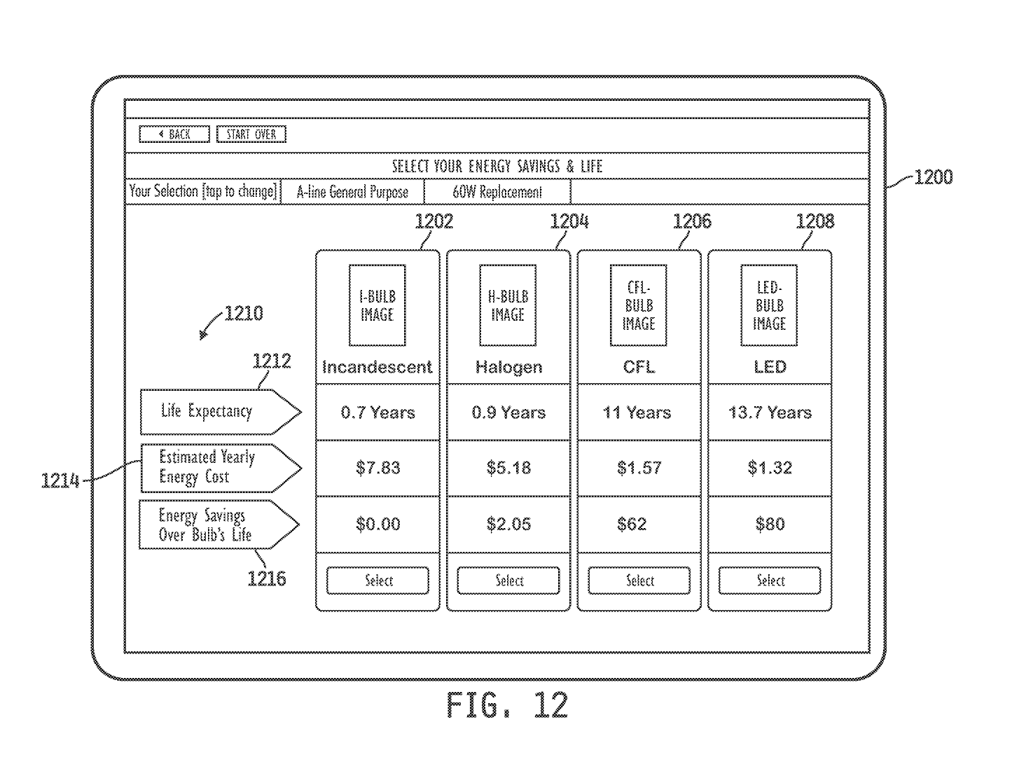

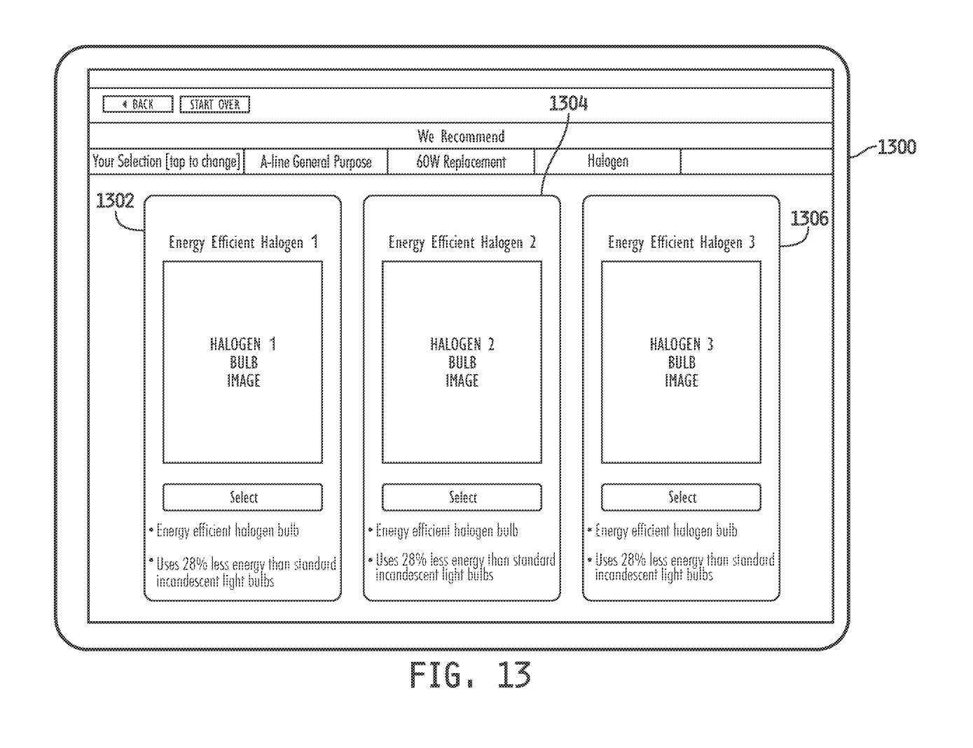

In the screen shot 900 illustrated in FIG. 9, the customer has selected General Purpose 802 as the bulb type, and in the screen shot 1000 illustrated in FIG. 10 the BSG App responds by displaying the various wattages of General Purpose light bulbs available for purchase at the retail enterprise. In particular, the various wattages include 40 Watt 1002, 60 Watt 1004, 75 Watt 1006 and 100 Watt 1008. As illustrated in the screen shot 1100 illustrated in FIG. 11, the customer has selected 60 Watt 1004 as the bulb being sought, and the BSG App responds, pursuant to step 504 of the process 500, by displaying the various technology choices of the selected lamp type in the screen shot 1200 illustrated in FIG. 12. The technology choices for the selected bulb type include Incandescent 1202, Halogen 1204, CFL 1206 and LED 1208. As also illustrated in FIG. 12, the process 500 in this example includes step 506 by including a graphical representation 1210 of cost and performance comparisons between the four display technology choices. In the illustrated example, the cost and performance comparisons include life expectancy 1212, estimated yearly energy cost 1214 and energy savings over bulb's life 1216 for each of the four display technology choices.

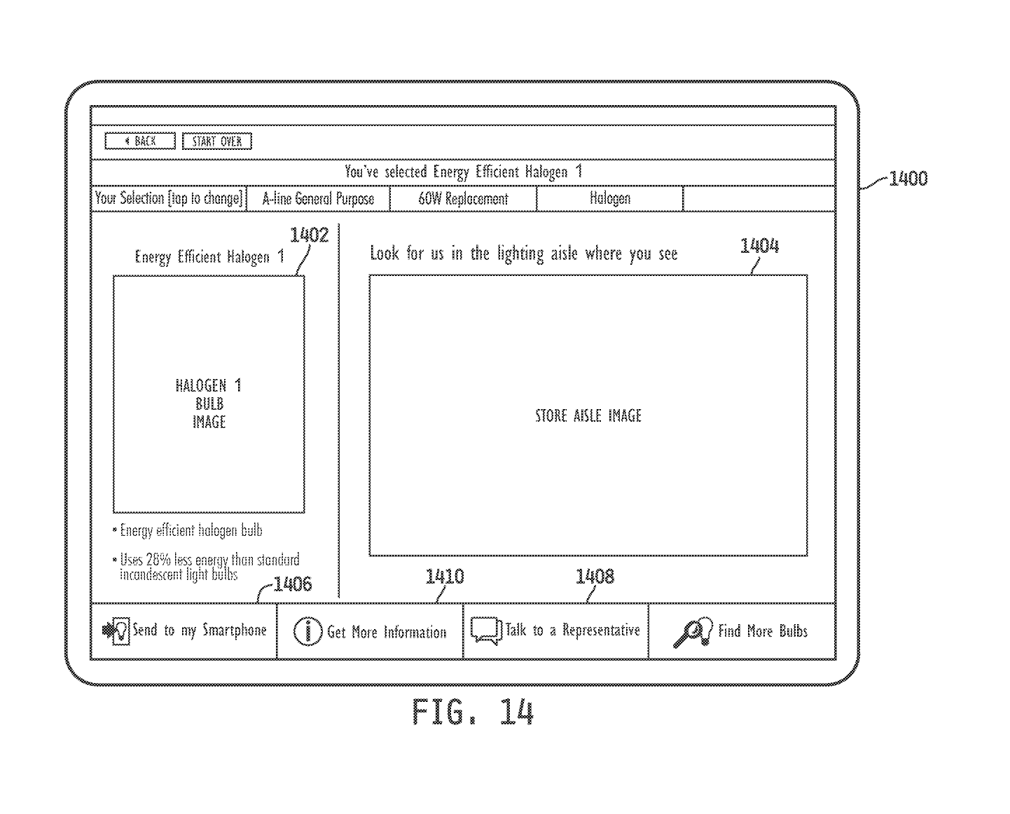

In the illustrated example, the customer has selected the halogen option 1204, pursuant to step 510 of the process 500, and the BSG App responds, pursuant to step 512 of the process 500, by displaying the available versions of the bulb from the selected technology option as illustrated in the example screen shot 1300 of FIG. 13. In the illustrated embodiment, the available bulbs include a reveal® bulb 1302, a Soft White® bulb 1304 and a Long Life Soft White® bulb 1306. As shown in the example screen shot 1400 of FIG. 14, the customer has selected the reveal® bulb 1402 pursuant to step 514, and the process 500 illustratively include step 516 as the selected bulb 1402 is displayed in the screen shot 1400. The process 500 illustrated in FIG. 14 further includes step 518 as the area 1404 of the screen shot 1400 depicts a planogram of the retail shelving highlighting the location of the selected bulb. The process 500 illustrated in FIG. 14 further includes step 522 of the process 500 as the screen shot 1400 includes a selectable graphic 1406 for transmitting the image of the selected bulb 1402 to the customer's smart phone. The process 500 illustrated in FIG. 14 further include step 524 of the process 500 as the screen shot 1400 includes a selectable graphic 1408 to talk to a vendor representative. Illustratively, the screen shot 1400 further includes a selectable graphic 1410 via which the customer may obtain further information about the specific bulb selected and/or about light bulbs generally, e.g., from the bulb information database 404.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A method of providing a customer with product purchase guidance in a retail environment, comprising:
controlling a display device with a processor to display a plurality of selectable bulb type graphical user interface (GUI) elements each corresponding to a different one of a plurality of light bulb types,
in response to receipt by the processor of a signal or message indicating manual selection via a user interface device of one of the displayed plurality of selectable bulb type GUI elements, controlling the display device with the processor to display one or more selectable bulb technology GUI elements each corresponding to a different one of one or more light bulb technologies in which the selected light bulb type is manufactured,
in response to receipt by the processor of a signal or message indicating manual selection via the user interface device of one of the displayed one or more selectable bulb technology GUI elements, controlling the display device with the processor to display one or more selectable bulb variant GUI elements each corresponding to a different one of one or more variants in which the selected light bulb technology of the selected light bulb type is manufactured, and
in response to receipt by the processor of a signal or message indicating manual selection via the user interface device of one of the displayed one or more selectable bulb variant GUI elements, controlling the display device with the processor to display the selected variant of the selected light bulb technology of the selected light bulb type.

2. The method of claim 1 further comprising controlling the display device with the processor to display a planogram highlighting a location of the selected variant of the selected light bulb technology of the selected light bulb type relative to retail shelving located in the retail environment.

3. The method of claim 2 further comprising controlling with the processor wireless communication circuitry coupled thereto to transmit to an identified mobile communication device an image of the highlighted planogram.

4. The method of claim 3 further comprising:
receiving via wireless communication circuitry coupled to the processor a wirelessly transmitted signal or message including at least one code, and
processing by the processor of the wirelessly received at least one code to identify the mobile communication device for purposes of transmitting thereto the image of the highlighted planogram.

5. The method of claim 1 further comprising controlling with the processor wireless communication circuitry coupled thereto to transmit to an identified mobile communication device information about selected variant of the selected light bulb technology of the selected light bulb type.

6. The method of claim 5 further comprising:
receiving via wireless communication circuitry coupled to the processor a wirelessly transmitted signal or message including at least one code, and
processing by the processor of the wirelessly received at least one code to identify the mobile communication device for purposes of transmitting thereto the information about selected variant of the selected light bulb technology of the selected light bulb type.

7. The method of claim 4 wherein the information about the selected variant of the selected light bulb technology of the selected light bulb type includes an image of the selected variant of the selected light bulb technology of the selected light bulb type.

8. The method of claim 1 wherein the retail environment includes therein retail shelving having stocked thereon a plurality of different light bulbs for retail sale, and a light bulb identification system configured to selectively highlight locations of one or more of the plurality of different light bulbs stocked on the retail shelving, and wherein the method further comprises controlling with the processor the light bulb identification system to highlight a location of the retail shelving at which the selected variant of the selected light bulb technology of the selected light bulb type is located.

9. The method of claim 1 wherein controlling the display device to display the plurality of selectable bulb type graphical user interface (GUI) elements comprises:
controlling the display device with the processor to display a plurality of selectable light bulb application GUI elements each corresponding to a different one of a plurality of light bulb applications in which light bulbs are used, and
in response to receipt by the processor of a signal or message indicating manual selection via the user interface device of one of the displayed plurality of selectable light bulb application GUI elements, accessing with the processor a database of light bulb information and determining therefrom the plurality of light bulb types as a subset of a plurality of light bulbs usable in the selected light bulb application.

10. The method of claim 1 wherein controlling the display device to display the plurality of selectable bulb type graphical user interface (GUI) elements comprises:
controlling the display device with the processor to display a plurality of selectable light bulb fixture GUI elements each corresponding to a different one of a plurality of light bulb fixtures in which light bulbs are used, and
in response to receipt by the processor of a signal or message indicating manual selection via the user interface device of one of the displayed plurality of selectable light bulb fixture GUI elements, accessing with the processor a database of light bulb information and determining therefrom the plurality of light bulb types as a subset of a plurality of light bulbs usable with the selected light bulb fixture.

11. The method of claim 10 wherein controlling the display device to display the plurality of selectable light bulb fixture GUI elements comprises:
controlling the display device with the processor to display a plurality of selectable light bulb fixture type GUI elements each corresponding to a different one of a plurality of types of light bulb fixtures in which light bulbs are used,
in response to receipt by the processor of a signal or message indicating manual selection via the user interface device of one of the displayed plurality of selectable light bulb fixture type GUI elements, controlling the display device with the processor to display a plurality of selectable light bulb fixture manufacturer GUI elements each corresponding to a different one of one or more light fixture manufacturers that manufacture the selected type of light bulb fixture, and
accessing with the processor a database of light bulb information and determining therefrom the plurality of light bulb types as the subset of a plurality of light bulbs usable with the selected light bulb fixture type and manufactured by the selected light bulb fixture manufacturer.

12. The method of claim 11 wherein controlling the display device to display the plurality of selectable light bulb fixture GUI elements further comprises controlling the display device with the processor to display a plurality of selectable light bulb fixture model GUI elements each corresponding to a different one of one or more light bulb fixture models of the selected light bulb fixture type and manufactured by the selected light bulb fixture manufacturer,
and wherein determining the plurality of light bulb types further comprises accessing with the processor the database of light bulb information and determining therefrom the plurality of light bulb types as a subset of the plurality of light bulbs usable with the selected light bulb fixture model of the selected light bulb fixture type that is manufactured by the selected light bulb fixture manufacturer.

13. The method of claim 1 wherein controlling the display device to display the plurality of selectable bulb type graphical user interface (GUI) elements comprises:
controlling the display device with the processor to display a plurality of selectable light bulb shape GUI elements each corresponding to a different one of a plurality of light bulb shapes, and
in response to receipt by the processor of a signal or message indicating manual selection via the user interface device of one of the displayed plurality of selectable light bulb shape GUI elements, accessing with the processor a database of light bulb information and determining therefrom the plurality of light bulb types as a subset of a plurality of light bulbs each having the selected light bulb shape.

14. The method of claim 1 wherein controlling the display device to display the plurality of selectable bulb type graphical user interface (GUI) elements comprises:
controlling the display device with the processor to display a plurality of selectable light bulb size GUI elements each corresponding to a different one of a plurality of light bulb sizes, and
in response to receipt by the processor of a signal or message indicating manual selection via the user interface device of one of the displayed plurality of selectable light bulb size GUI elements, accessing with the processor a database of light bulb information and determining therefrom the plurality of light bulb types as a subset of a plurality of light bulbs each having the selected light bulb size.

15. The method of claim 1 wherein controlling the display device to display the plurality of selectable bulb type graphical user interface (GUI) elements comprises:
controlling the display device with the processor to display a plurality of selectable light bulb output GUI elements each corresponding to a different one of a plurality of light output or electrical power consumption values, and
in response to receipt by the processor of a signal or message indicating manual selection via the user interface device of one of the displayed plurality of selectable light bulb output GUI elements, accessing with the processor a database of light bulb information and determining therefrom the plurality of light bulb types as a subset of a plurality of light bulbs each having the selected light bulb light output or electrical power consumption values.

16. The method of claim 1 wherein controlling the display device to display the one or more selectable bulb technology GUI elements comprises controlling the display device with the processor to display the selected light bulb type in the form of one or more of an incandescent bulb, a fluorescent bulb and a light emitting diode bulb.

17. The method of claim 1 wherein controlling the display device with the processor to display one or more selectable bulb variant GUI elements comprises controlling the display device with the processor to display the selected light bulb technology of the selected light bulb type in the form of one or more of a color temperature, color rendering index (CRI), estimated bulb lifetime, energy-efficiency, coating type, clear, colored and shatter-resistant option.

18. A system for providing a customer with product purchase guidance in a retail environment, the system comprising:
a display device,
a user interface device,
a processer coupled to the display device and to the user input device, and
a memory having instructions stored therein which, when executed by the processor, cause the processor to control the display device to display a plurality of selectable bulb type graphical user interface (GUI) elements each corresponding to a different one of a plurality of light bulb types, to control the display device, in response to receipt of a signal or message indicating manual selection via the user interface device of one of the displayed plurality of selectable bulb type GUI elements, to display one or more selectable bulb technology GUI elements each corresponding to a different one of one or more light bulb technologies in which the selected light bulb type is manufactured, to control the display device, in response to receipt of a signal or message indicating manual selection via the user interface device of one of the displayed one or more selectable bulb technology GUI elements, to display one or more selectable bulb variant GUI elements each corresponding to a different one of one or more variants in which the selected light bulb technology of the selected light bulb type is manufactured, and to control the display device, in response to receipt of a signal or message indicating manual selection via the user interface device of one of the displayed one or more selectable bulb variant GUI elements, to display the selected variant of the selected light bulb technology of the selected light bulb type.

19. The system of claim 18 wherein the instructions stored in the memory further include instructions which, when executed by the processor, cause the processor to control the display device to display a planogram highlighting a location of the selected variant of the selected light bulb technology of the selected light bulb type relative to retail shelving located in the retail environment.

20. The system of claim 18 further comprising wireless communication circuitry coupled to the processor,
and wherein the instructions stored in the memory further include instructions which, when executed by the processor, cause the processor to control the wireless communication circuitry to transmit to an identified mobile communication device at least one of a planogram highlighting a location of the selected variant of the selected light bulb technology of the selected light bulb type relative to retail shelving located in the retail environment and an image of the selected variant of the selected light bulb technology of the selected light bulb type.
